(19) United States
(12) Patent Application Publication
(10) Pub. No.: US 2005/0128734 A1
(43) Pub. Date: Jun. 16, 2005

(54) Rotatable lighting decoration

(76) Inventor: Fong-Shi Lin, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/731,013

(22) Filed: Dec. 10, 2003

(51) Int. Cl. F21V 21/30

(52) U.S. Cl. 362/35

(57) ABSTRACT

The invention relates to a rotatable lighting decoration, which includes a supporting frame to connect with a motor having a link for connecting with a patterned decoration with light string. The motor can rotate the decoration and the string at the same time to obtain a rotary lighting decoration.

### BACKGROUND OF THE INVENTION

A conventional lighting decoration usually includes a rigid structure connecting with light strings. The decoration can although be designed to be various figures but it is still a fixed configuration with an unchanged outlook always. The decorative effect is poor and monologue however.

Accordingly, the present invention is to provide a rotatable lighting decoration, which can rotate automatically for providing a better lighting purpose. Now, accompanying with the following drawings, the character of the present invention will be described here and after.

### BRIEF DESCRIPTION OF THE DRAWINGS

FIG. 1 is a perspective view showing a rotatable lighting decoration according to the present invention.

FIG. 2 is a plan view of FIG. 1 with partly cross-sectional view.

### DETAILED DESCRIPTION OF THE PREFERRED EMBODIMENT

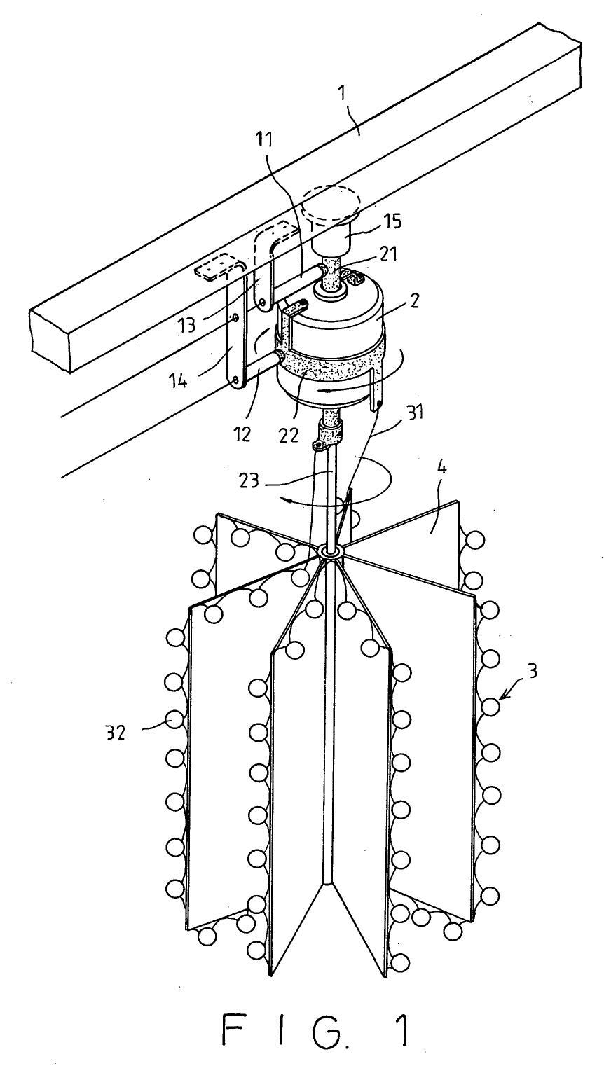

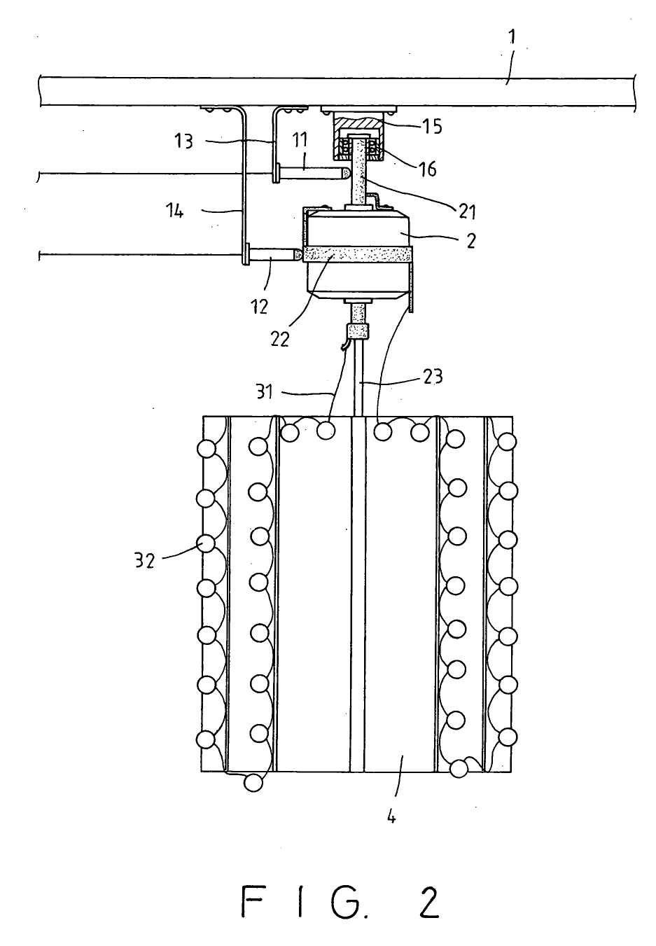

Please referring to FIGS. 1 and 2, the present invention relates to a rotatable lighting decoration, which includes a supporting frame (1) with two downward connecting slices (13), (14). Two conductive pins (11), (12) are mounted respectively on the two connecting slices (13), (14). One of the conductive pins connects with an electrical wire connected to positive pole of power source and the other connects with another electrical wire connected to negative pole of power source. A joint (15) having an inner bearing (16) is provided under the frame (1) for holding a conductive rod (21) of a motor (2), which has a conductive ring (22) around the body of the motor (2). Two conductive pins (11), (12) contact with the conductive rod (21) and the conductive ring (22) respectively for electrical connection therebetween. A patterned decoration (4) is connected with a link (23) mounted under the motor (2). A light string (3) is capable of being hung on the decoration (4), wherein two ends of the electrical wire (31) of the string (3) are connected with the conductive rod (21) and the conductive ring (22) respectively.

When the power is turned on, the two conductive pins (11), (12), the conductive rod (21), the conductive ring (22), and the electrical wire (31) of the string (3) consist a complete circuit that the bulbs (32) can be lightened accordingly. At the same time, the motor (2) begins to rotate while the decoration (4) with the string (3) can be rotated simultaneously. The pins (11), (12) are always contacting with the surface of the rod (21) and ring (22), and the string (3) is rotated as well as the decoration (4) and the motor (2). Hence, the wire (31) of the string (3) will not be winding disturbedly.

Accordingly, the invented assembly of the present invention has a rotatable lighting decoration, which can be patterned as desired, wherein the motor can rotate as soon as power is on and the lighting decoration is rotated at the same time that obtains a better decorative effect than ever before.

1. A rotatable lighting decoration including a supporting frame with two downward connecting slices, two conductive pins being mounted respectively on the two connecting slices, wherein one of the conductive pins connects with an electrical wire connected to positive pole of power source and the other connects with another electrical wire connected to negative pole of power source; a joint having an inner bearing being provided under the frame for holding a conductive rod of a motor, which has a conductive ring around the body of the motor, and the said two conductive pins contacting with the conductive rod and the conductive ring respectively for electrical connection therebetween, and a patterned decoration being connected with a link mounted under the motor, a light string being hung on the decoration, wherein two ends of the electrical wire of the string are connected with the conductive rod and the conductive ring respectively.
